(19) United States
(12) Patent Application Publication
(10) Pub. No.: US 2002/0107893 A1
(43) Pub. Date: Aug. 8, 2002

(54) Method and system for displaying data with tree structure

(75) Inventors: Kazuya Ohkouchi, Yokohama (JP); Toyohisa Morita, Sagamihara (JP); Yukiyasu Itou, Fujisawa (JP)

Correspondence Address: McDermott, Will & Emery, 600, 13th Street, N.W., Washington, DC, 20005-3096, US

(73) Assignee: Hitachi, Ltd.

(21) Appl. No.: 10/060,238

(22) Filed: Feb. 1, 2002

(30) Foreign Application Priority Data
Feb. 2, 2001 (JP) 2001-026251

(51) Int. Cl. G06F 17/24

(52) U.S. Cl. 707/514; 707/526

(57) ABSTRACT

According to the present invention, a designation of a data identifier name (leaf name or node name, for example) displayed with a tree structure is received, the identifier name (root node name, for example) of an other tree structure to which the data identifier name so designated belongs is displayed, a designation for the other tree structure identifier name so displayed is received, and other data identifier names (parent node name in an upper level, or other leaf name or node name in the same layer, for example) belonging to the other tree structure so designated are displayed.

### BACKGROUND OF THE INVENTION

1. Field of the Invention

This invention relates to a method, system, and program for displaying data names classified hierarchically using a layered structure and, more particularly, a tree structure, such, for example, as a method, system, and program for displaying directories or folders in a tree structure in order to manage files that are collections of data.

2. Description of the Related Art

The classification of files or mail using one tree structure with file management software or mail management software run on a computer is disclosed in “‘UNIX’ P. 95, FIG. 7, 3(a), by Haruhisa Ishida, Kyoritsu Shuppan, November, 1983.”

JP-A-2000-132438 discloses imparting one or more attributes to each individual file, and associating those attributes to the layers in a tree structure in order to artificially define a tree structure and manage files. JP-A-2000-132438 further discloses imparting order relationships to the attributes noted above, associating those attribute order relationships to upper-level or lower levels or the like in the tree structure, treating classifications by these attributes as tree structure nodes, and treating the end files that are the smallest units in this classification method as leaves, thereby effecting functions similar to those in file directory management which uses conventional tree structures. JPA-2000-132438 further discloses the building of a plurality of tree structures by defining a plurality of these order relationships.

In “‘UNIX’ P. 95, FIG. 7, 3(a), by Haruhisa Ishida, Kyoritsu Shuppan, November, 1983,” because the classification of data sets with a classification method [derived] from a single type of classification criterion is imposed, when there is a plurality of classification criteria in the data, viewpoints other than some classification criterion are sacrificed. For that reason, if, after classifying data with some criterion and accommodating those data in a tree structure, an attempt is made to reference those data with an other classification criterion, the current tree structure will be destroyed, making it necessary to reclassify the data from the beginning. Accordingly, with this method, the concept of classifying some data with a plurality of classification criteria, investigating to determine how one datum in that data set is accommodated in the several tree structures, and comparing that, classification method by classification method, is not in view.

In JP-A-2000-132438, the attribute order relationships are associated with the layer relationships of the tree structure. Let it be assumed, for example, that the five attributes A, B, C, ALPHA, and BETA have been imparted to a file. When to these attributes the order relationships “attributes A, B, and C are equal,” “attributes ALPHA and BETA are equal,” and “A >ALPHA” are imparted, the nodes A, B, and C belong immediately below the root node, and to those nodes, respectively, belong the nodes ALPHA and BETA. Accordingly, only the same child node can be made to belong to nodes in layers at the same level. Accordingly, in [the scheme described in] JP-A-2000-132438, although a plurality of tree structures can be built artificially, the tree structures that can be configured are very limited.

### SUMMARY OF THE INVENTION

An object of the present invention is to provide a data display method, together with a system and program therefor, capable of easily selecting and displaying a plurality of tree structures to which one datum belongs.

According to the present invention, a designation for an identifier name (such as a leaf name or node name, for example) of data displayed by a tree structure is received, an identifier name (root node name, for example) of an other tree structure to which the identifier name of the data designated belongs is displayed, a designation for the identifier name of the other tree structure displayed is received, and the identifier names (such as the parent node name of an upper level or an other leaf name or node name in the same layer, for example) of other data belonging to the other tree structure are displayed.

The present invention, alternatively, comprises a management table that includes the identifier names of tree structures to which a data identifier name belongs, corresponding to the data identifier name, and a management table that includes the identifier names ( ) of other data, in the tree structure to which the identifier name of the data belongs.

Based on the present invention, when attention is given to the identifier name of some data, and the identifier name of other data belonging to the identifier name of data in an upper level in one classification method for the identifier name of those data is displayed, the identifier name of data belonging to the identifier name of data in an upper level in an other classification method for the identifier name of those data can easily be displayed. For example, an other node or leaf belonging to the same parent node in one classification method constitutes related data in the sense of being classified in the same parent node by some one judgment criterion, from a root node. That being so, based on the present invention, when data related to some leaf are being referenced in one classification method or viewpoint, related data in an other classification method can easily be referenced. Thereby, one data set can be referenced from various viewpoints, centered on one leaf therein.

### BRIEF DESCRIPTION OF THE DRAWINGS

FIG. 1 is a configuration diagram of one example of an apparatus in an embodiment aspect;

FIG. 2 is an overall process flowchart;

FIG. 3 represents the configuration of a tree structure information accommodating table;

FIG. 4 represents the configuration of node information;

FIG. 5 represents the configuration of node information;

FIG. 6 represents one example of a tree structure wherewith the display is switched by display modification processing;

FIG. 7 is a flowchart for display modification processing;

FIG. 8 represents screen examples of display modification processing;

FIG. 9 is a flowchart representing details of tree structure management processing;

FIG. 10 is a flowchart for leaf addition processing;

FIG. 11 is a flowchart for leaf deletion processing;

FIG. 12 is a flowchart for node addition processing;

FIG. 13 is a flowchart for node deletion processing;

FIG. 14 is a flowchart for processing to delete a node/leaf belonging to some node;

FIG. 15 is a flowchart for tree structure addition processing;

FIG. 16 is a flowchart for tree structure deletion processing;

FIG. 17 represents an example of display screen switching in OLAP;

FIG. 18 represents a tree structure expressed in an OLAP axis;

FIG. 19 represents screen examples in mail management software; and

FIG. 20 represents an example of an initial tree structure.

### DESCRIPTION OF THE PREFERRED EMBODIMENTS

Detailed descriptions are now given of embodiment aspects of the present invention.

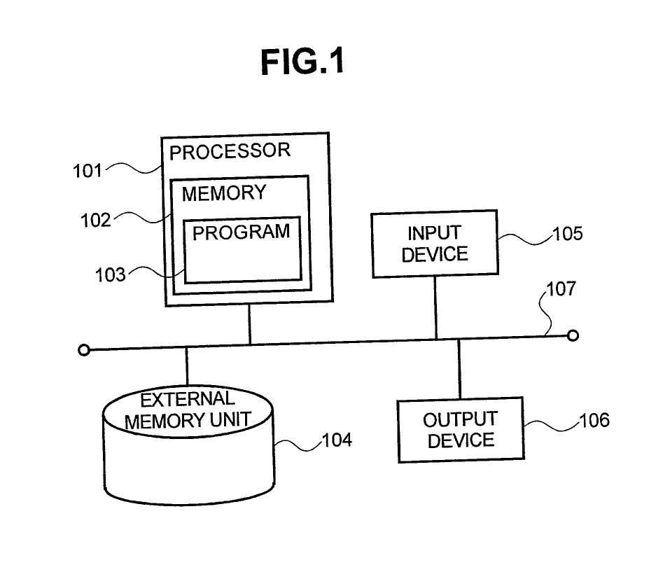

FIG. 1 is a system configuration diagram for one example of an apparatus in an embodiment aspect of the present invention.

The system comprises a processor 101 (CPU or the like) for interpreting the program and executing prescribed processing, an external memory unit 104 (hard disk drive or the like) for such as data and programs, an input device 105 (keyboard or the like) for receiving inputs from a user, and an output device 106 (printer or the like) for outputting data. These pieces of equipment are connected by a bus 107 for transferring information. The processor 101 comprises a memory 102 (RAM or the like) for storing such as data and programs. The memory 102 is a memory contained internally in the processor 101, and is used as a temporary storage place for a program or data needed by the processing being performed by the processor 101. The program 103 is a program that is stored in the memory 102, coded with processing routines for displaying data. In the external memory unit 104 is stored information relating to data display, comprising at least a tree structure management table, node information, and leaf information. The input device 105 is a device such as a keyboard or mouse or the like for communicating user instructions to the processor 101. The output device 106 is a device such as a display for displaying the results of processing performed by the processor 101.

A general description of processing for embodying the present invention is given below.

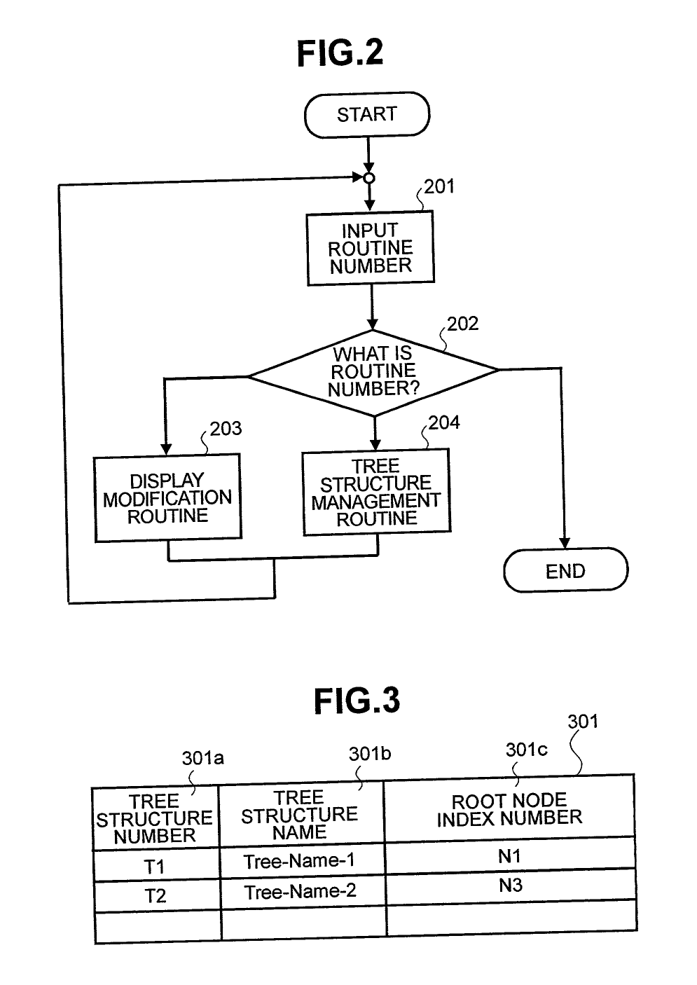

FIG. 2 is an overall process flowchart for the present invention.

In step 201, a process number is input, from the input device 105, to identify a process. In step 202, the process number input in step 201 is distinguished, and either step 203, step 204, or END is selected. Step 203 is a display modification processing step, [wherein,] in one tree structure (layer structure), attention is given to a leaf on the screen of the output device 106 that is emphatically displayed, and switching is effected from a screen wherein all leaves and nodes, including a selected node, belonging to the parent node of that leaf are being displayed, to a screen wherein all leaves and nodes, including that selected leaf, belonging to the parent node of that selected leaf, of a different tree structure, are displayed. It is preferable that the selected node be display emphatically also in the screen after switching has been effected.

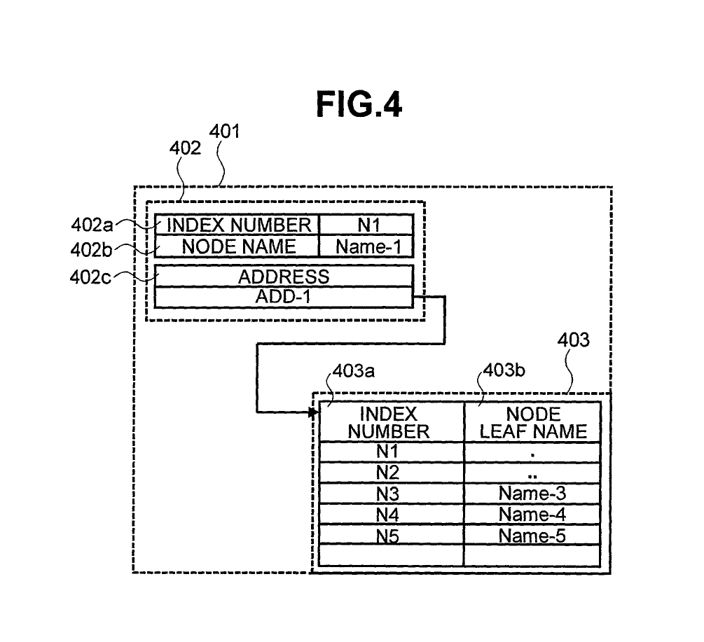

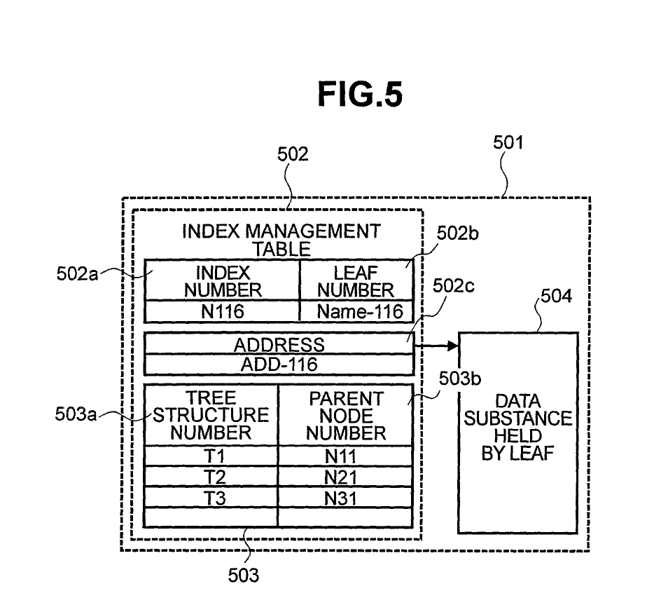

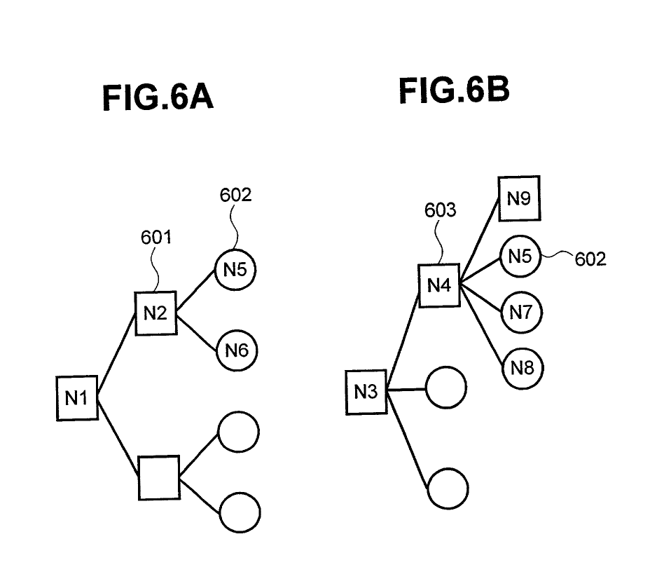

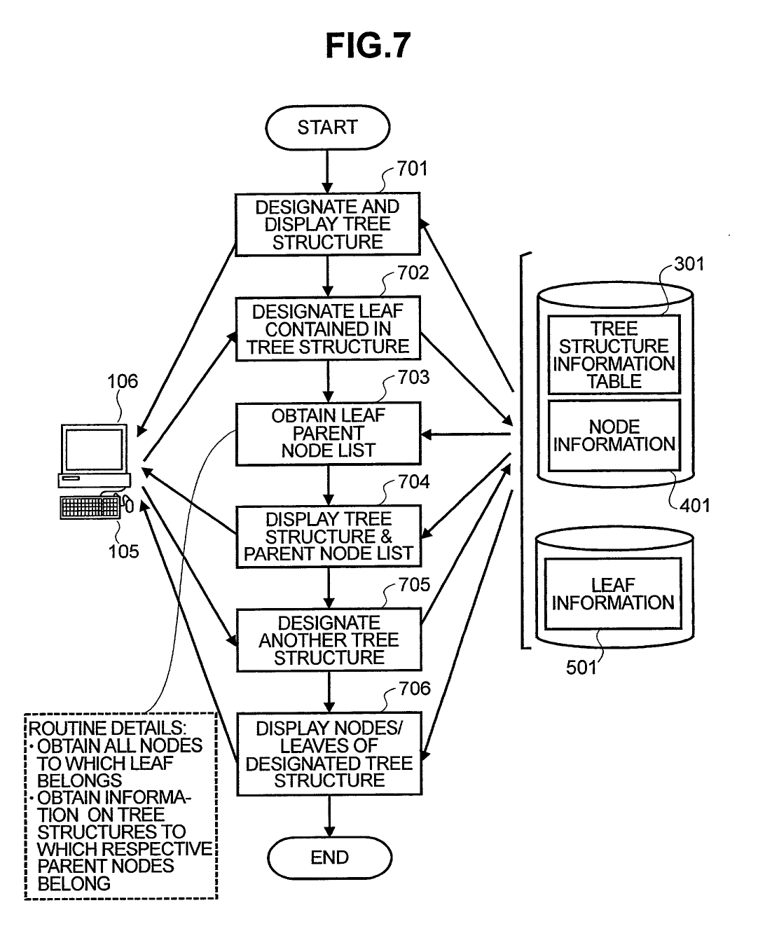

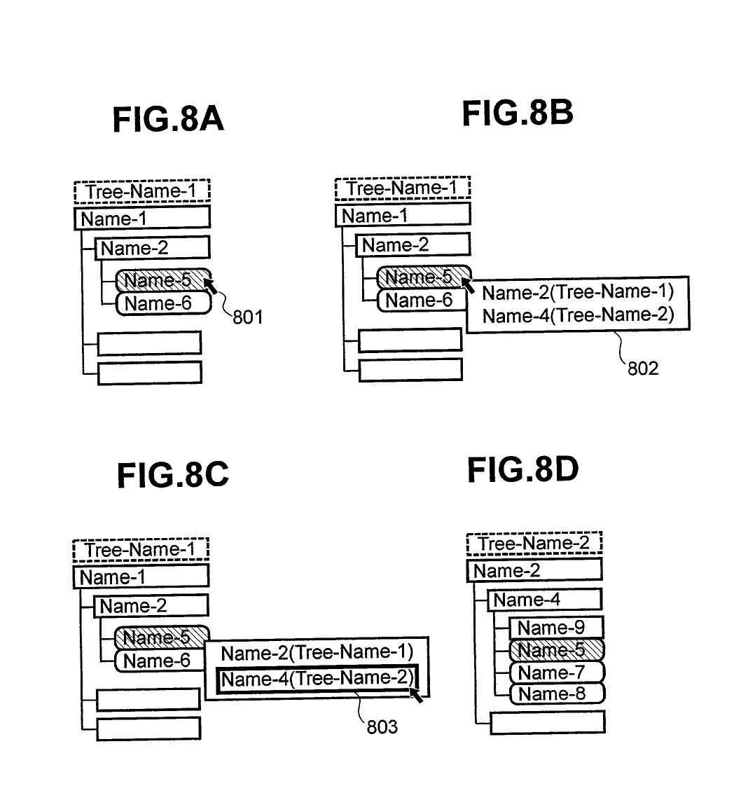

The display modification processing of step 203 is described with reference to FIG. 3, FIG. 4, the table in FIG. 5, the tree structure diagrammed in FIG. 6, the flowchart given in FIG. 7, and the display screen examples diagrammed in FIG. 8.

FIG. 3 represents an example of a tree structure information table 301 used in step 203.

The tree structure information table 301 can hold information relating to a plurality of tree structures. The tree structure information table 301 is of variable size, and is effected by an array, or link structure, or combination thereof, of sufficient size. In the tree structure information table 301 is stored information containing at least a tree structure number 301a for identifying the tree structure, a tree structure name 301b for identifying the tree structure, and a root node index number 301c for identifying a root node. The tree structure number 301a is a number assigned to tree structures one by one, the values whereof are unequivocal among all tree structures. The tree structure name 301b is a name given to a tree structure. In the root node index number 301c, the index number of the root node for that tree structure is stored. The index numbers are unequivocal among the nodes and leaves contained in all tree structures.

FIG. 4 represents one example of node information 401 used in step 203. The node information 401 contains an index management table 402 and a node information management table 403. In the index management table 402 is stored information containing at least an index number 402a for identifying a node, a node name 402b for identifying a node, and an address 402c for a node information management table. The index number 402a is a number assigned to that node, which is unequivocal among the nodes and leaves contained in all tree structures. The node name 402b is a name given to a node. The address 402c is the lead address in the memory 102 or external memory unit 104 where the node information management table 403 is stored. In the node information management table 403 is stored information containing index numbers 403a (N1, N2, N3, N4, N5) for this node (Name-1) itself, the parent node (upper-level node) of this node (Name-1), and nodes and leaves (lower-level nodes and leaves, Name-3, Name-4, Name-5) belonging to this node, and node/leaf names 403b (Name-3, Name-4, Name-5). The node name for this node is “.” The node name for the parent node of this node is “..” The node information management table 403 is of variable size, and should be effected by an array, or link structure, or combination thereof, of sufficient size. There is no absolute need for the index management table 402 and node information management table 403 to be stored in contiguous areas in the external memory unit 104.

FIG. 5 represents one example of leaf information 501 used in step 203. The leaf information 501 includes an index management table 502 and a leaf substance 504. In the index management table 502 is stored information containing at least an index number 502a for identifying a leaf, a leaf name 502b for identifying a leaf, a leaf address 502c, and a parent node information management table 503. The index number 502a is a number assigned to that leaf, and is unequivocal among the nodes and leaves contained in all tree structures. The leaf name 502b is a name given to a leaf. The address 502c is the lead address in the memory 102 or external memory unit 104 where the leaf substance 504 is stored. In the parent node information management table 503 are contained a tree structure number 503a and a parent node number 503b to which that leaf belongs. The tree structure number 503a is the number of the tree structure to which this leaf belongs. The parent node number 503b is the index number of the parent node for this leaf, in the tree structure specified by the corresponding tree structure number. The parent node information management table 503 is of variable size, and should be effected by an array, or link structure, or combination thereof, of sufficient size.

Presupposing these data structures, the processing procedures for the display modification processing [in step] 203 are described with reference to the tree structures diagrammed in FIG. 6, the flowchart in FIG. 7, and the display screen examples in FIG. 8.

FIG. 6 represents tree structures. The square symbols represent tree structure nodes, while the circle symbols represent leaves. With display modification processing 203, in one tree structure like the tree structure diagrammed in FIG. 6A, a node 601 and all or some of the nodes and leaves belonging to that node are displayed. When out of those leaves one leaf 602 or node is focused on, and an instruction to that leaf or node is received from a user, the screen display is switched to a screen that displays a parent node 603 for that leaf 602 in a different tree structure (FIG. 6B), and all or some of the nodes/leaves belonging to that node 603.

The term node (directory or folder) as used here includes nodes and/or leaves in a lower level. The nodes are, in FIG. 6A, for example, N1 and N2. By leaf (file) is meant that which does not contain a node or leaf in a lower level, that is, an end entity (in lowest-level layer). The leaves are, in FIG. 6A, for example, N5 and N6. By parent node is meant an upper level node to which a node or leaf belongs (such as a node in a layer one level up or a node in a layer two levels up, for example). In FIG. 6A, for example, the parent node of the leaf N5 is N2, and the parent node of N2 is N1. By root node (root directory) is meant a node that contains a node or leaf in a lower level but contains no nodes or leaves in any upper level, that is, the apex (highest-level layer) node in the tree structure. N1 in FIG. 6A is an example of a root node. It is desirable, moreover, that one tree structure correspond to one classification criterion for classifying leaves. In the embodiment aspect of the present invention, the case is assumed where one leaf or node belongs to a plurality of classification criteria, [and] belongs to a plurality of tree structures (parent nodes). That is, as diagrammed in FIG. 6, for example, the leaf N5, while belonging to the tree structure having the root node N1 (FIG. 6A), also belongs to the tree structure having the root node N3. The tree structure name should be the name of the root node of that tree structure name, but it may also be the data classification name, or the name of a node other than the root node, that is, the name of a node in a lower level relative to the root node. The name of the tree structure of the parent node of the designated leaf 801 or node may also be the same. For example, in FIG. 6B, the parent node (Name-2) of the leaf (Name-5) and the tree structure name of the parent node (Name-5) may be the same.

The details of the processing procedures for display modification processing 203 are now described with reference to the flowchart in FIG. 7.

In FIG. 7 are diagrammed the input device 105, output device 106, memory device containing the data structure data described with reference to FIG. 3, 4, and 5, and a flowchart indicating the process flow. This processing is executed by the processor 101 in accordance with the program 103. The arrows going from the processing routines in the flowchart to the input device 105 and output device 106 represent the output of the results of those processing routines to the output device 106, while the arrows going from the input device 105 and output device 106 to the processing routines in the flowchart represent the receiving and processing of inputs from the input device 105. Similarly, the arrows from the processing routines in the flowchart to the memory device represent the storing of the results of those processing routines in the memory device, while the arrows from the memory device to the processing routines in the flowchart represent the execution of those processing routines using data in the memory device.

In step 701, one tree structure is displayed. Furthermore, a plurality of tree structures may be displayed. In step 702, the designation of one leaf contained in the tree structure displayed in step 701 is received from the input device 105.

In FIG. 8 is diagrammed the transition of display screens from the designation of a leaf or node belonging to any tree structure to the display of an other tree structure to which that designated leaf or node belongs (transition in order of FIG. 8A→FIG. 8B→FIG. 8C→FIG. 8D). The case where the leaf 801 is designated is described below, but a node may be designated instead of the leaf 801.

FIG. 8A represents an example of a screen in step 702. FIG. 8A diagrams an example of one screen wherein the one leaf 801 has been designated in the tree structure currently being displayed. The designated leaf 801 is emphatically displayed.

In step 703, a list of all or some of the tree structure numbers 503a to which the designated leaf belongs and of the index numbers 503b of the parent nodes thereof is obtained from the parent node information management table 503. That is, from the leaf information 501 in the memory 102 or external memory unit 104, the index management table 502 is obtained, using the leaf name 502D of the designated leaf 801 as a key. The parent node information management table 503 contained in the obtained index management table is the parent node information management table 503 corresponding to the designated leaf. From the parent node information management table 503 corresponding to the designated leaf 801, all or some (one or a plurality) of the tree structure numbers 503a and parent node numbers 503b are obtained. Based on the tree structure information table 301, the tree structure name 301b corresponding to the tree structure number 503 is obtained.

In step 704, for all or some of the tree structure numbers 503a and parent node index numbers 503b, obtained in step 702, based on the tree structure numbers 503a, the tree structure names 301b (such as “Tree-Name-1” or “Tree-Name-2,” for example) corresponding to those tree structure numbers 503a are obtained from the tree structure information table 301, and the node names 402b (such as “Name-2” or “Name-4,” for example) of the parent nodes are obtained from the index management table 402 of the node information 401. based on the index numbers 503b of the parent nodes. The tree structure names 301b and node names 402b of the parent nodes so obtained are output to the output device 106.

FIG. 8B represents an example of a screen in step 703. This is an example of one screen wherein, in a condition wherein a leaf has been selected, a list 802 of the node names of all or some (one or a plurality) of the parent nodes and of the tree structure names of all or some (one or a plurality) of the tree structures to which that leaf belongs is displayed. That is, the list 802 is popped up alongside the designated node (Name-5). However, it is also permissible to display only a list of node names of parent nodes, or only a list of tree structure names of tree structures, or both. Furthermore, the list 802 may contain all or some of the tree structures (Tree-Name-1 and Tree-Name-2) containing the tree structure (Tree-Name-1) currently being focused on, or it may contain only all or some of the tree structures (Tree-Name-2) excluding the tree structure (Tree-Name-1) currently focused on. In other words, the list 802 should at least contain all or some of the other tree structures (Tree-Name-2).

In step 705, the designation of one tree structure, or parent node, from out of the list output is received from the input device 105. That is, the designation of an other tree structure is received.

FIG. 8C represents an example of a screen in step 705. This is an example of one screen wherein one tree structure 803, or parent node, is designated from out of the list displayed in FIG. 8B. The designated tree structure 803, or parent node, is emphatically displayed.

In step 706, a list of leafs and nodes belonging to the parent node of the tree structure (“Tree-Name-2,” for example) containing the designated tree structure (“Tree-Name-2,” for example) or the designated parent node (“Name-4,” for example), is obtained from the node information management table 402, and displayed on the screen. That is, from the parent node information management table 503 of the leaf information 501 stored in either the memory 102 or external memory unit 104, the parent node number 503b corresponding to the designated tree structure 803 is obtained. From the node information 401 stored in either the memory 102 or external memory unit 104, the index management table 402 for the obtained parent node number 503b is obtained with the tree structure number 503a of the designated tree structure 803. From the leaf information 501 stored in either the memory 102 or external memory unit 104, the node information management table 403 is obtained, based on the address 402c of the obtained index management table 402. The node/leaf names 403b contained in the node information management table 403 so obtained are the node/leaf names of the leaves and nodes belonging to that parent node, of the designated tree structure or of a tree structure containing the designated parent node.

FIG. 8D represents an example of a screen in step 706. This is an example of one screen wherein, in the tree structure designated in step 705, a list of the leaves and nodes belonging to the parent node of that leaf is displayed on the screen. That is, of the tree structures (“Tree-Name-2,” for example) designated in step 705, the nodes and leaves of a parent node (“Name-2,” for example) containing the leaf (“Name-5,” for example) designated in step 702 are displayed. From within that parent node (“Name-2,” for example), the parallel layers (“Name-9,” “Name-7,” and “Name-8,” for example) and/or upper levels (“Name-4” being an upper level of “Name-5,” and “Name-2” being an upper level of “Name-4,” for example) of the leaf (“Name-5,” for example) designated in step 702 are also displayed. Also, the leaf (“Name-5,” for example) designated in step 702 is emphatically displayed.

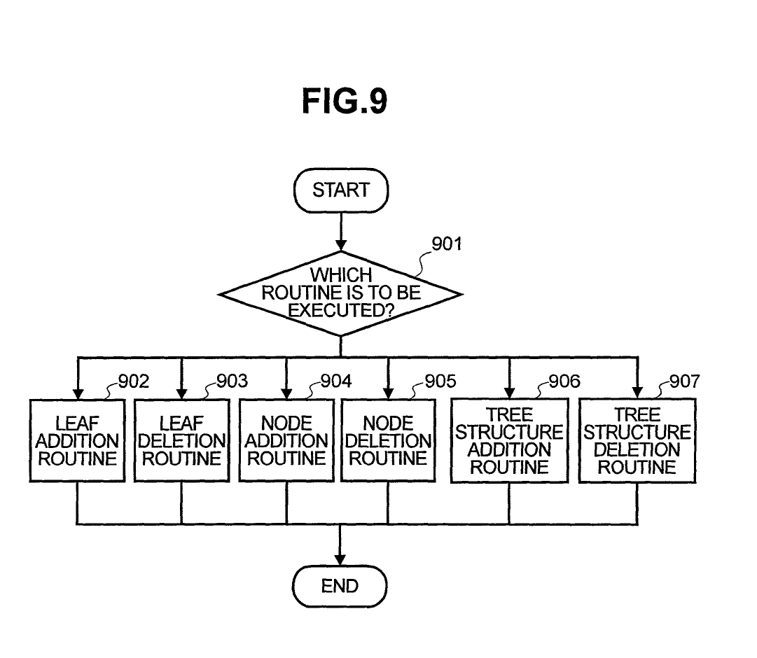

In FIG. 9 is given a detailed flowchart for step 204. Step 204 is a structure management processing routine which performs processing for managing the tree structures handled in the present invention. Each processing procedure is the same as in step 203, and the data structures diagrammed in FIG. 3, 4, and 5 are used.

In step 901, either step 902, step 903, step 904, step 905, step 906, or step 907 is selected, depending on the process that is to be executed. One or other of step 902, step 903, step 904, step 905, step 906, and step 907 is selected by an input from the input device 105.

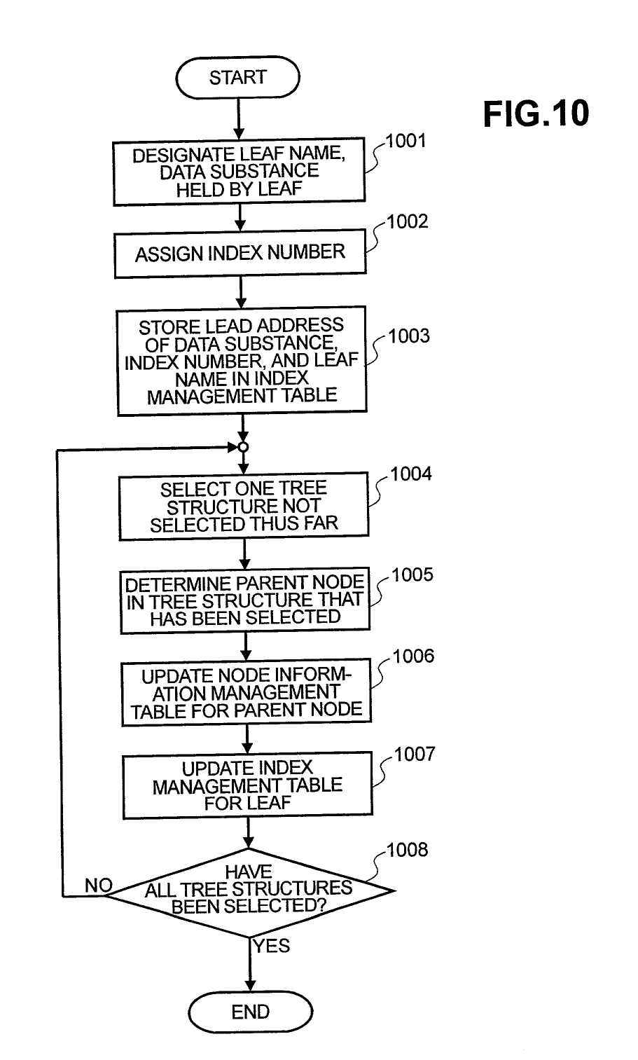

In FIG. 10 is given a detailed flowchart for step 902. Step 902 is a leaf addition routine, being a routine that adds a leaf to one tree structure.

In step 1001, the name of the leaf being added, and a designation of the data substance held by that leaf, are received. In step 1002, an index number is assigned to the leaf being added so that there is no overlap with index numbers used thus far. In step 1003, the leaf name, the lead address of the data area where the data substance held by the leaf are stored, and the leaf index number are stored in the index management table 502 for that leaf. In step 1004, one tree structure not selected thus far is selected. In step 1005, the parent node of the leaf being added, in the selected tree structure, is designated. In step 1006, the name 403b and index number 403a of that leaf are stored in the node information management table 403 of the parent node. In step 1007, the tree structure number 503a and parent node index number 503b of the selected tree structure are added to the parent node information management table 503 of the leaf being added. In step 1008, a check is made to determine whether all of the tree structures have been selected in step 1004; if YES, the routine is ended, and if NO, step 1004 is moved to.

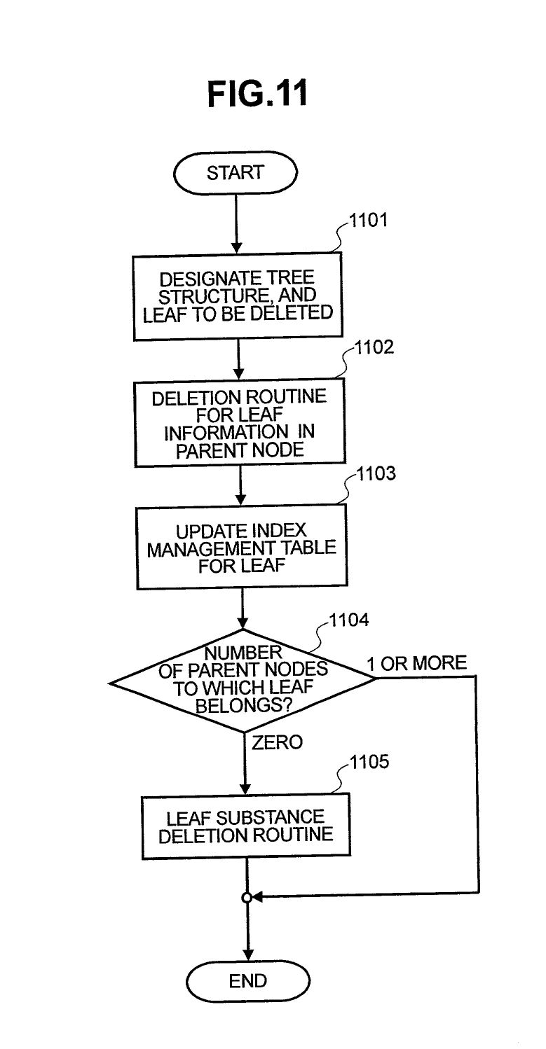

In FIG. 11 is given a detailed flowchart for step 903. Step 903 is leaf deletion routine, being a routine that deletes a leaf from one tree structure.

In step 1101, a designation of the tree structure from which the leaf is being deleted and the leaf to be deleted is received. In step 1102, the index number 403a and name 403b of the leaf being deleted are deleted from the index management table 402 of the parent node of the leaf being deleted, in the tree structure designated in step 1101. In step 1103, the tree structure number 503a of the tree structure designated in step 1101 and the index number 503b of the parent node in that tree structure are deleted from the index management table 502 of the leaf being deleted. In step 1104, the number of parent nodes to which the leaf belongs is checked against the index management table 502; if that number is 1 or greater, the routine is ended, and if zero, step 1105 is moved to. In step 1105, all leaf information for the leaf being deleted is deleted. Thus it becomes possible to reuse the index number that this leaf had been using.

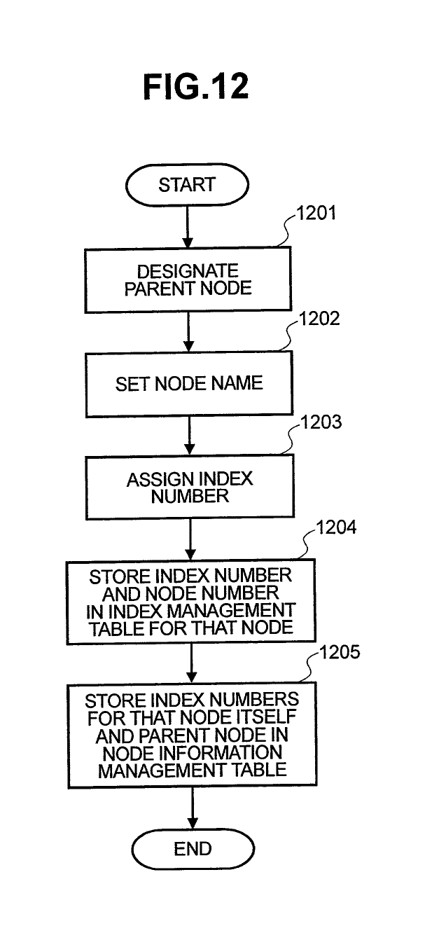

In FIG. 12 is given a detailed flowchart for step 904. Step 904 is a node addition routine, being a routine that newly adds a node to one tree structure.

In step 1201, the node that is to become the parent node of the node to be added is designated. In step 1202, the name of the node being added is designated. In step 1203, an index number is assigned to the node being added, so that there is no overlap with index numbers used thus far. In step 1204, the node name and index number determined in step 1202 and step 1203 are stored in the index management table 402 of this node. In step 1205, the index number 403a and node name 403b of the node added, and the index name 403a and node name 403b of the parent node of the node added, are stored in the node information management table 403 of the node added. Here, the node name of the added node that is stored is made “.” and the node name of the parent node thereof is made “..”

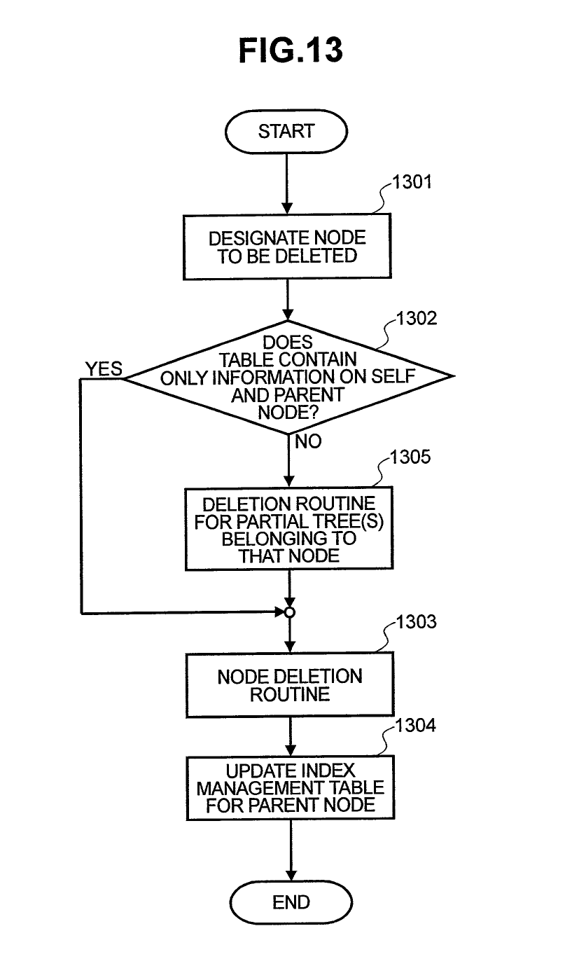

In FIG. 13 is given a detailed flowchart for step 905. Step 905 is a node deletion routine, being a routine that deletes a node from one tree structure.

In step 1301, the node to be deleted is designated. In step 1302, the node information management table 403 is checked; if the information stored is only information relating to one's own node and information relating to one's own parent node, step 1303 is branched to, otherwise, step 1305 is moved to. In step 1303, the node information management table 403 and index management table 402 are deleted. Thereby, the index number that was being used by this node becomes usable by an other leaf or node. In step 1304, the index number 402a of the deleted node and the node name 402b of the deleted node, which are being stored in the node information management table 403 corresponding to the index management table 402 of the parent node of the deleted node, are deleted. In step 1305, a partial tree deletion routine is called as an entity for deleting all nodes and leaves belonging to the selected node.

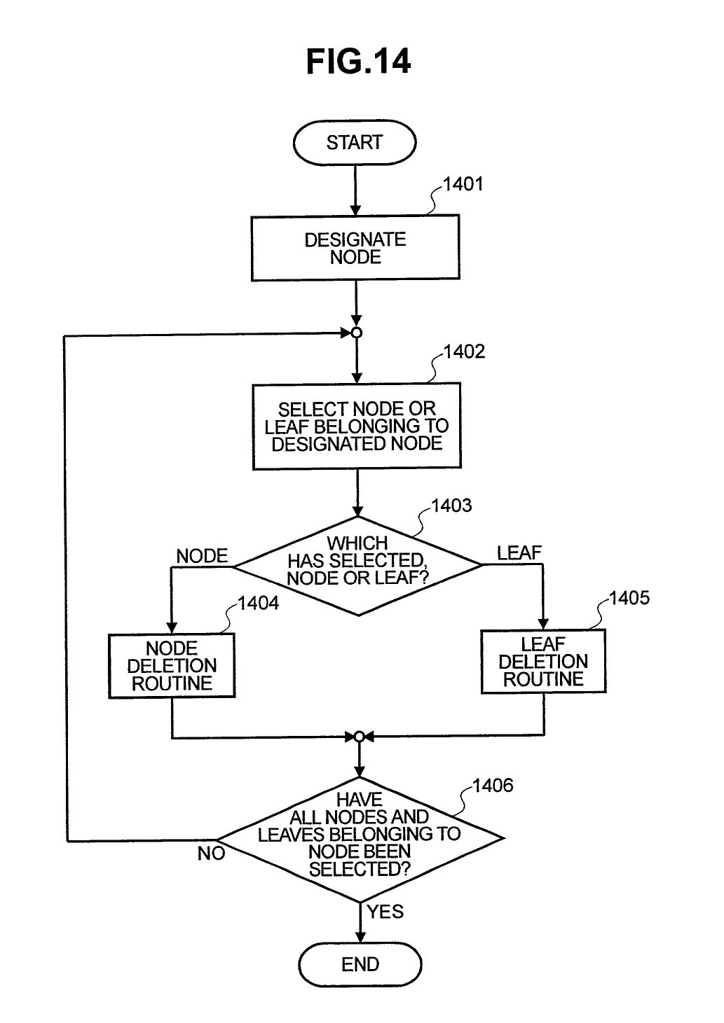

In FIG. 14 are represented the details of the partial tree deletion routine called in step 1305. FIG. 14 gives a flowchart wherein are written processing procedures for the deletion routine 1305 for a partial tree belonging to some node.

In step 1401, one node is designated. In step 1402, a node or leaf belonging to the node selected in step 1401 is selected. In step 1403, step 1404 is moved to if a node was selected in step 1402, and step 1405 is moved to if a leaf was selected. In step 1404, a node deletion routine 905 is called as an entity for deleting the node selected in step 1402. In step 1405, a leaf deletion routine 903 is called as an entity for deleting the leaf selected in step 1402 in the tree structure to which the node designated in step 1401 belongs. In step 1406, a check is made to determine whether or not all of the nodes and leaves belonging to the node have been selected; if YES, the routine is ended, and if NO, step 1401 is moved to.

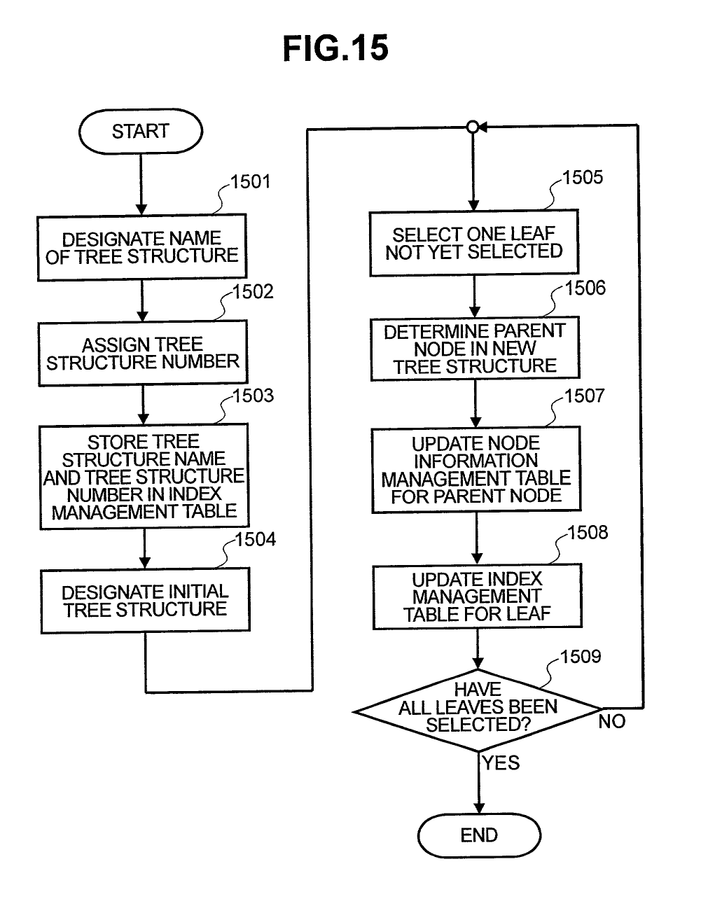

In FIG. 15 is given a detailed flowchart for step 906. Step 906 is a tree structure addition routine, being a routine for adding/producing a new tree structure.

In step 1501, the name of a tree structure is designated. In step 1502, a tree structure number is assigned so that there is no overlap with an existing tree structure number. In step 1503, the tree structure name and tree structure number determined in step 1501 and step 1502 are stored in the tree structure information table 301. In step 1504, the initial structure of the tree structure being produced is designated. The initial structure produced is a tree structure having only a root node. In step 1505, from all of the leaves, one leaf that has not yet been selected in this step is selected. In step 1506, the parent node of the selected leaf is determined. This determination sets beforehand the conditions for determining which node a leaf is to belong to. In step 1507, in order to cause the leaf to belong to the parent node determined in step 1506, the leaf index number 403a and leaf name 403b are stored in the node information management table 403 of the parent node. In step 1508, in order to cause the leaf to belong to the parent node determined in step 1506, the tree structure number 503a of this tree structure and the index number 503b of this parent node are stored in the parent node information management table 503 of this leaf. In step 1509, a decision is made as to whether or not all of the leaves were selected in step 1505; if YES, the routine is ended, and if NO, step 1505 is moved to.

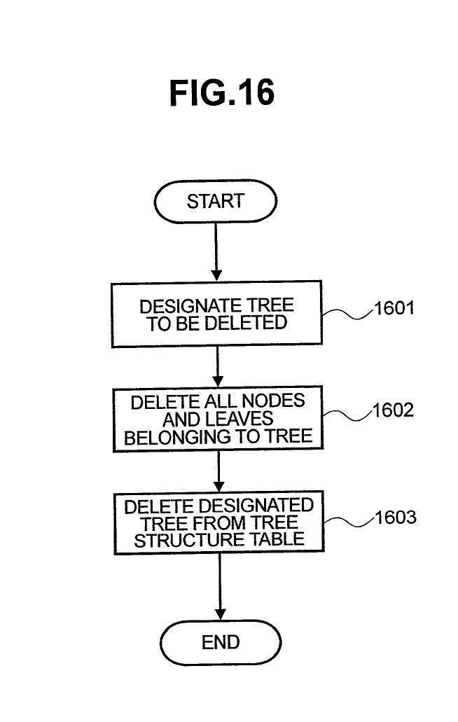

In FIG. 16 is given a flowchart for step 907. Step 907 is a tree structure deletion routine, being a routine for deleting a tree structure that is registered in the tree structure information table 301.

In step 1601, the tree structure to be deleted is designated. In step 1602, the node deletion routine step 905 is called as an entity for deleting the root node of this tree structure. In step 1608, the tree structure number 301a, tree structure name 301b, and root node index number 301c of the tree structure designated in step 1601 are deleted from the tree structure information table 301.

Based on the embodiment aspect described in the foregoing, information on a plurality of tree structures, and information on the nodes and leaves belonging to those tree structures, are held by tree structure information tables and node information, and, for leaves belonging to those tree structures, by having the leaves in the parent node information management table hold information on all of the parent nodes to which those leaves belong, data sets can be managed using a plurality of tree structures having any structure, based on the plurality of classification methods thereof.

Based on this embodiment aspect, moreover, when some leaf is focused on, and other nodes and leaves belonging to the parent node of that leaf in one classification method are displayed, the nodes and leaves belonging to the parent node of that leaf in an other classification method can be displayed. In one classification method, other nodes and leaves belonging to the same parent node can be called related data in the sense that they can be classified in the same parent node, passing [thereto] by some path from the root node. Accordingly, based on this embodiment aspect, when data are referenced which are related to some leaf in one classification method, data related to that leaf in a different classification method can be referenced quickly. In other words, one data set can be referenced quickly from various viewpoints, centered on one leaf therein.

It is also possible to embody this embodiment aspect in the modified way described below.

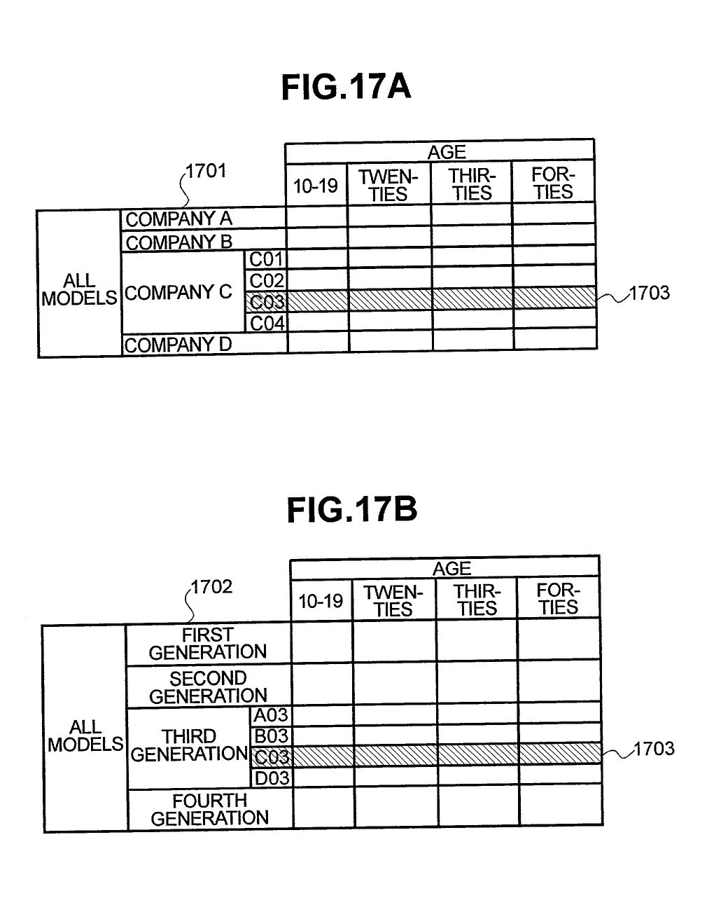

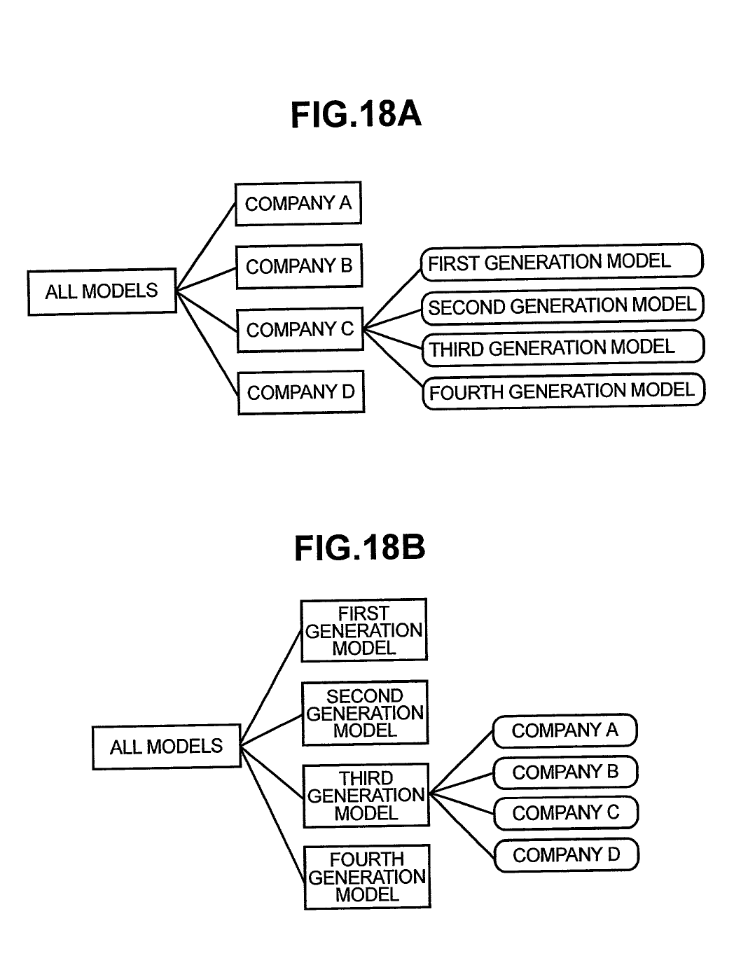

First, in OLAP (on-line analytical processing), when a variable classification method is expressed by a tree structure, the first embodiment aspect can be embodied by applying a tree structure to one axis, as diagrammed in FIG. 17, for example. A detailed description of this first modified example is now given, making reference to FIG. 17 and FIG. 18.

FIG. 17 diagrams example screens for displaying the results of a drill down using a common OLAP tool. In FIG. 17A, sales for all models of portable telephones are drilled down by manufacturing company, then drilled down by manufacture generation for the products of company C, and the results displayed. This is equivalent to implementing a classification by a classification method for portable telephone sales wherein all the models of portable telephone are made the root node, and classification is made by manufacturing company at the level below that, and by generation at the level below that. In other words, the classification method of axis 1701 can be viewed as equivalent to the tree structure diagrammed in FIG. 18A.

In FIG. 17B, on the other hand, the results of doing drill down using a different classification method are displayed. In this case, all the models of portable telephone are first drilled down for manufacturing generation, and then drill down by manufacturing company is done for the third generation models thereof. In other words, axis 1702 is viewed as being equivalent to the tree structure diagrammed in FIG. 18B.

By executing the display modification routine 203 so that the tree structures diagrammed in FIG. 18A and 18B are managed with the tree structure information table 301 in the first embodiment aspect, the nodes and leaves belonging to that tree structure are managed with the node information 401 and leaf information 501 data structures, a leaf belonging to the tree structure diagrammed in FIG. 18A is designated, the display is modified to the classification method based on the tree structure diagrammed in FIG. 18B, and the screen wherein is displayed sales comparisons by manufacture generation for the same manufacturing company in FIG. 17A, similarly, can be switched to the screen of sales comparisons by manufacturing company for the same manufacture generation in FIG. 17B. Here, in the substance of the data of the leaf information 501, sales information by age relating to the portable telephone model called “C03” indicated with data 1703, for example, is contained. However, data 1703 are the data in the portion indicated by the cross-hatching in FIG. 17A. It should be noted that, in this embodiment aspect, the parent node is changed from manufacture generations to manufacturing company names without modifying the tree structure name (all models).

Conventionally, in order to perform this kind of display modification while using OLAP, it was necessary first to destroy the results of one drill down, and then drill-down once more from the root node. According to this modification example, however, when changing the screen display from a screen displaying the results of one drill down to a screen displaying the results of another drill down, a related analysis screen can readily be shifted to without drilling down the target axis from an other root node.

Secondly, the first embodiment aspect can be embodied by, when managing mail, changing the nodes to folders when assigning mail, and the leaves to mail substances (mail titles, for example).

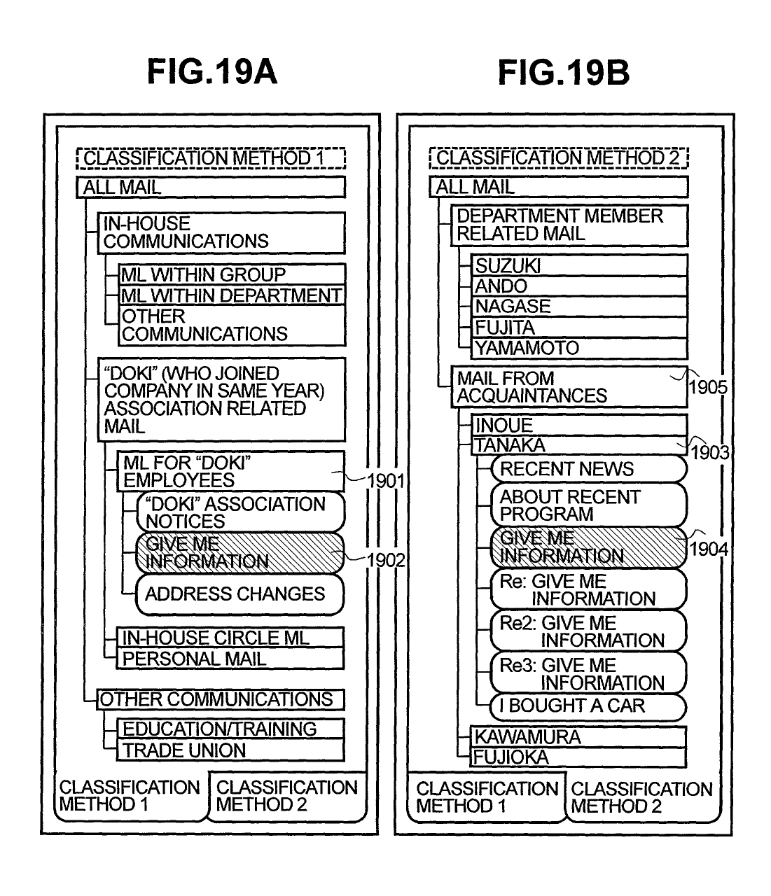

FIG. 19 diagrams one example of screens that effect this embodiment. FIG. 19A represents a case where, in the classification method 1, a folder called “Doki Employee ML” 1901 (where “doki” refers to employees who joined an organization in the same hiring season) is opened, and mail contained in that folder and having the subject “Please teach/tell me” 1902 is indicated. In FIG. 19B, where the display method has been switched to the classification method 2, the folder “Tanaka” 1903 is opened, and related mail exchanged with a person named “Tanaka” concerning the mail called “Please teach/tell me” 1904 is displayed. The switching of the screens, from that diagrammed in FIG. 19A to that diagrammed in FIG. 19B, is done by the display modification routine 203, which manages mail with the tree structure information table 301 viewing the classification methods of mail respectively as tree structures, manages the mail folders, viewing them as nodes, with the node information 401 data structure, manages respective mail items, viewing them as leaves, with the leaf information 501 data structure, designates mail in the classification method of FIG. 19A, and modifies the display to a classification method based on the classification method of FIG. 19B. By executing the display conversion routine 203, the screen diagrammed in FIG. 19A wherein mail related to the “Doki Employee ML” 1901 is displayed can be switched to a screen wherein is displayed mail related to “Tanaka” and defined at a lower level of “Mail From Acquaintances” 1905 such as indicated in FIG. 19B.

As another example of the second modification example which can be used, in a case of mail classification such as where a businessman classifies mail by project and [also] classifies mail by the person the mail is exchanged with, a screen wherein mail is displayed related by project and a screen for mail related by the person the mail is exchanged with are switched between using some mail as a criterion. That is, according to this modification example, mail can be classified from a plurality of viewpoints, and mail related in the plurality of viewpoints can easily be referenced.

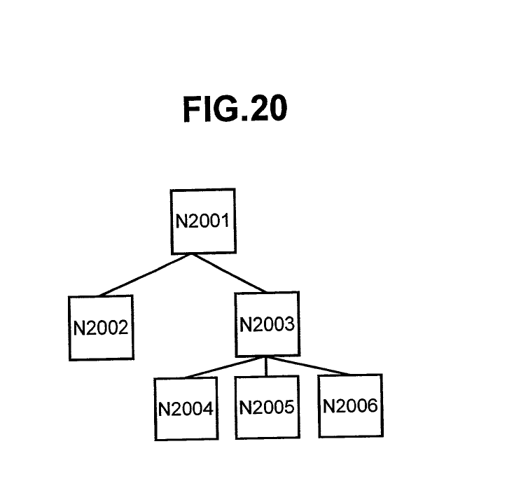

Thirdly, the initial tree structure generated in step 1504 can be produced by designating a tree structure of any shape containing only nodes as shown in FIG. 20 for example, and executing the node addition routine 904 described in FIG. 9 a plural number of times. According to this modification example, cases can be handled where the shape of the tree structure has been set beforehand. In FIG. 12, moreover, the squares represent nodes, and the numbers inside the squares are node index numbers.

Fourthly, by following the tree structure to the root node, using the parent node information stored in the index management table 402 for the node, instead of using the node name of the parent node displayed in step 703 in FIG. 7, and storing in memory the nodes passed in that process, a path from the root node to the node name of the parent node can be displayed. According to this modification example, in cases where that classification method is difficult to understand with only the parent node list for the leaf being focused on, more information for understanding the classification method can be obtained by verifying the path from the root node.

### DRAWINGS

FIG. 1:

101 PROCESSOR

102 MEMORY

103 PROGRAM

104 EXTERNAL MEMORY UNIT

105 INPUT DEVICE

106 OUTPUT DEVICE

FIG. 2:

START

201 INPUT ROUTINE NUMBER

202 WHAT IS ROUTINE NUMBER?

203 DISPLAY MODIFICATION ROUTINE

204 TREE STRUCTURE MANAGEMENT ROUTINE

END

FIG. 3:

TREE STRUCTURE NUMBER

TREE STRUCTURE NAME

ROOT NODE INDEX NUMBER

FIG. 4:

INDEX NUMBER

NODE NAME

ADDRESS

INDEX NUMBER

NODE LEAF NAME

FIG. 5:

INDEX MANAGEMENT TABLE

INDEX NUMBER

LEAF NUMBER

ADDRESS

TREE STRUCTURE NUMBER

PARENT NODE NUMBER

DATA SUBSTANCE HELD BY LEAF

FIG. 7:

START

701 DESIGNATE AND DISPLAY TREE STRUCTURE

702 DESIGNATE LEAF CONTAINED IN TREE STRUCTURE

703 OBTAIN LEAF PARENT NODE LIST

704 DISPLAY TREE STRUCTURE & PARENT NODE LIST

705 DESIGNATE AN OTHER TREE STRUCTURE

706 DISPLAY NODES/LEAVES OF DESIGNATED TREE STRUCTURE

END

301 TREE STRUCTURE INFORMATION TABLE

401 NODE INFORMATION

501 LEAF INFORMATION

ROUTINE DETAILS:

OBTAIN ALL NODES TO WHICH LEAF BELONGS

OBTAIN INFORMATION ON TREE STRUCTURES TO WHICH RESPECTIVE PARENT NODES BELONG

FIG. 9:

START

901 WHICH ROUTINE IS TO BE EXECUTED?

902 LEAF ADDITION ROUTINE

903 LEAF DELETION ROUTINE

904 NODE ADDITION ROUTINE

905 NODE DELETION ROUTINE

906 TREE STRUCTURE ADDITION ROUTINE

907 TREE STRUCTURE DELETION ROUTINE

END

FIG. 10:

START

1001 DESIGNATE LEAF NAME, DATA SUBSTANCE HELD BY LEAF

1002 ASSIGN INDEX NUMBER

1003 STORE LEAD ADDRESS OF DATA SUBSTANCE, INDEX NUMBER, AND LEAF NAME IN INDEX MANAGEMENT TABLE

1004 SELECT ONE TREE STRUCTURE NOT SELECTED THUS FAR

1005 DETERMINE PARENT NODE IN TREE STRUCTURE THAT HAS BEEN SELECTED

1006 UPDATE NODE INFORMATION MANAGEMENT TABLE FOR PARENT NODE

1007 UPDATE INDEX MANAGEMENT TABLE FOR LEAF

1008 HAVE ALL TREE STRUCTURES BEEN SELECTED?

END

FIG. 11:

START

1101 DESIGNATE TREE STRUCTURE, AND LEAF TO BE DELETED

1102 DELETION ROUTINE FOR LEAF INFORMATION IN PARENT NODE

1103 UPDATE INDEX MANAGEMENT TABLE FOR LEAF

1104 NUMBER OF PARENT NODES TO WHICH LEAF BELONGS?

1 OR MORE

ZERO

1105 LEAF SUBSTANCE DELETION ROUTINE

END

FIG. 12:

START

1201 DESIGNATE PARENT NODE

1202 SET NODE NAME

1203 ASSIGN INDEX NUMBER

1204 STORE INDEX NUMBER AND NODE NUMBER IN INDEX MANAGEMENT TABLE FOR THAT NODE

1205 STORE INDEX NUMBERS FOR THAT NODE ITSELF AND

PARENT NODE IN NODE INFORMATION MANAGEMENT TABLE

END

FIG. 13:

START

1301 DESIGNATE NODE TO BE DELETED

1302 DOES TABLE CONTAIN ONLY INFORMATION ON SELF AND PARENT NODE?

1305 DELETION ROUTINE FOR PARTIAL TREE(S) BELONGING TO THAT NODE

1303 NODE DELETION ROUTINE

1304 UPDATE INDEX MANAGEMENT TABLE FOR PARENT NODE END

FIG. 14:

START

1401 DESIGNATE NODE

1402 SELECT NODE OR LEAF BELONGING TO DESIGNATED

NODE

1403 WHICH WAS SELECTED, NODE OR LEAF?

NODE

LEAF

1404 NODE DELETION ROUTINE

1405 LEAF DELETION ROUTINE

1406 HAVE ALL NODES AND LEAVES BELONGING TO NODE BEEN SELECTED?

END

FIG. 15:

START

1501 DESIGNATE NAME OF TREE STRUCTURE

1502 ASSIGN TREE STRUCTURE NUMBER

1503 STORE TREE STRUCTURE NAME AND TREE STRUCTURE NUMBER IN INDEX MANAGEMENT TABLE

1504 DESIGNATE INITIAL TREE STRUCTURE

1505 SELECT ONE LEAF NOT YET SELECTED

1506 DETERMINE PARENT NODE IN NEW TREE STRUCTURE

1507 UPDATE NODE INFORMATION MANAGEMENT TABLE FOR PARENT NODE

1508 UPDATE INDEX MANAGEMENT TABLE FOR LEAF

1509 HAVE ALL LEAVES BEEN SELECTED?

END

FIG. 16:

START

1601 DESIGNATE TREE TO BE DELETED

1602 DELETE ALL NODES AND LEAVES BELONGING TO TREE

1603 DELETE DESIGNATED TREE FROM TREE STRUCTURE

TABLE

END

FIG. 17A:

AGE

10-19

TWENTIES

THIRTIES

FORTIES

ALL MODELS

COMPANY A

COMPANY B

COMPANY C

COMPANY D

FIG. 17B

AGE

10-19

TWENTIES

THIRTIES

FORTIES

ALL MODELS

FIRST GENERATION

SECOND GENERATION

THIRD GENERATION

FOURTH GENERATION

FIG. 18A:

ALL MODELS

COMPANY A

COMPANY B

COMPANY C

COMPANY D

FIRST GENERATION MODEL

SECOND GENERATION MODEL

THIRD GENERATION MODEL

FOURTH GENERATION MODEL

FIG. 18B:

ALL MODELS

FIRST GENERATION MODEL

SECOND GENERATION MODEL

THIRD GENERATION MODEL

FOURTH GENERATION MODEL

COMPANY A

COMPANY B

COMPANY C

COMPANY D

FIG. 19A:

CLASSIFICATION METHOD 1

ALL MAIL

IN-HOUSE COMMUNICATIONS

ML WITHIN GROUP

ML WITHIN DEPARTMENT

OTHER COMMUNICATIONS

“DOKI” (WHO JOINED COMPANY IN SAME YEAR) ASSOCIATION RELATED MAIL

ML FOR “DOKI” EMPLOYEES

“DOKI” ASSOCIATION NOTICES

GIVE ME INFORMATION

ADDRESS CHANGES

IN-HOUSE CIRCLE ML

PERSONAL MAIL

OTHER COMMUNICATIONS

EDUCATION/TRAINING

TRADE UNION

CLASSIFICATION METHOD 1

CLASSIFICATION METHOD 2

FIG. 19B:

CLASSIFICATION METHOD 2

ALL MAIL

DEPARTMENT MEMBER RELATED MAIL

SUZUKI

ANDO

NAGASE

FUJITA

YAMAMOTO

MAIL FROM ACQUAINTANCES

INOUE

TANAKA

RECENT NEWS

ABOUT RECENT PROGRAM

GIVE ME INFORMATION

Re: GIVE ME INFORMATION

Re2: GIVE ME INFORMATION

Re3: GIVE ME INFORMATION

I BOUGHT A CAR

KAWAMURA

FUJIOKA

CLASSIFICATION METHOD 1

CLASSIFICATION METHOD 2

What is claimed is:

1. A data display method for displaying data identifier names with a tree structure, comprising the steps of:
receiving a designation for said data identifier name displayed with a tree structure;
displaying an identifier name of an other tree structure to which said data identifier name designated belongs;
receiving a designation for the identifier name of said other tree structure displayed; and
displaying identifier names of other data belonging to said other tree structure designated.

2. The data display method according to claim 1, wherein said step for displaying the identifier name of said other tree structure further comprises a step for obtaining the identifier name of said other tree structure, based on a parent node information management table containing the identifier name of said other tree structure to which said data identifier name belongs.

3. The data display method according to claim 1, wherein said step for displaying identifier names of said other data further comprises a step for obtaining the identifier names of said other data, based on a node information management table containing identifier names of other data belonging to said tree structure to which said data identifier name belongs.

4. The data display method according to claim 1, further comprising, when said data identifier name is to be added, the steps of:
receiving said data identifier name to be added;
receiving selection of a tree structure from tree structures which already exist and have not yet been selected;
receiving selection of an identifier name of data in an upper level in said selected tree structure;
adding said data identifier name to be added to a node information management table containing other data identifier names belonging to said tree structure to which said upper level data identifier name belongs, of said upper level data identifier name; and
producing a parent node information management table containing the identifier name of said tree structure to which said data identifier name belongs, of said data identifier name to be added, based on said tree structure selected.

5. The data display method according to claim 1, further comprising, when said tree structure is to be added, the steps of:
receiving identifier name of said tree structure to be added; receiving selection of said data identifier name from said data identifier names which already exist and have not yet been selected;
receiving selection of an identifier name of data in an upper level relative to said data identifier name selected, from said data identifier names which already exist and have not yet been selected;
adding said selected data identifier name to a node information management table containing other data identifier names belonging to said tree structure to which said upper level data identifier name belongs, of said upper level data identifier name; and
adding said tree structure identifier name to be added to a parent node information management table containing the identifier name of said tree structure to which said data identifier name belongs, of said selected data identifier name.

6. The data display method according to claim 1, wherein said step for displaying the identifier name of said other tree structure further comprises a step for displaying other data identifier names in an upper level relative to a designated data identifier name, in said other tree structure to which said data identifier name designated belongs.

7. The data display method according to claim 1, wherein, when said data identifier name is displayed with a tree structure, said data identifier name is displayed with a tree structure, based on a node information management table containing other data identifier names belonging to said tree structure to which said data identifier name belongs.

8. A data display system, for displaying data identifier names with a tree structure, comprising:
a processing unit for receiving a designation for said data identifier name displayed with a tree structure;
a processing unit for displaying the identifier name of an other tree structure to which said data identifier name designated belongs;
a processing unit for receiving a designation for the identifier name of said other tree structure displayed; and
a processing unit for displaying identifier names of other data belonging to said other tree structure designated.

9. A data display system, for displaying data identifier names with a tree structure, comprising an input device, an output device, a memory device and a processor;
wherein said processor receives, from said input device, a designation for said data identifier name output with a tree structure to said output device, outputs the identifier name of an other tree structure to which said data identifier name designated belongs to said output device, receives, from said input device, a designation for said other tree structure identifier name output to said output device, and outputs, to said output device, other data identifier names belonging to said other tree structure designated.

10. A data display system, for displaying data identifier names with a tree structure, comprising:
a memory device for storing a first management table containing said tree structure identifier name to which said data identifier name belong, and a second management table containing other data identifier name in said tree structure to which said data identifier names belongs; and
a processor which receives a designation for said data identifier name displayed with a tree structure, extracts the identifier name of an other tree structure to which said data identifier name designated belongs, based on said first management table, displays same on a display device, receives a designation for said other tree structure identifier name displayed, extracts other data identifier names belonging to said other tree structure designated, based on said second management table, and displays same on said display device.

11. A program, executable by a computer, for displaying data identifier names with a tree structure, comprising:
a code for receiving a designation for a data identifier name displayed with a tree structure;
a code for displaying the identifier name of an other tree structure to which said data identifier name designated belongs;
a code for receiving a designation for an identifier name of said other tree structure displayed; and
a code for displaying identifier names of other data belonging to said other tree structure designated.

12. A data display method for displaying data classified with tree structure variables, comprising the steps of:
receiving a designation for said variable name displayed with a tree structure;
displaying an other variable name to which said variable name designated belongs;
receiving designation for said other variable name displayed; and
displaying said data classified with said other variable name designated.

13. The data display method according to claim 1, wherein said step for displaying data further comprises a step for editing said data by said other variable name designated.

14. A data display system for displaying data classified with tree structure variables, comprising:
a processing unit for receiving a designation for said variable name displayed with a tree structure;
a processing unit for displaying an other variable name to which said variable name designated belongs;
a processing unit for receiving a designation for said other variable name displayed; and
a processing unit for displaying said data classified with said other variable name designated.

15. A program, executable by a computer, for displaying data classified with tree structure variables, comprising:
a code for receiving a designation for said variable name displayed with a tree structure;
a code for displaying an other variable name to which said variable name designated belongs;
a code for receiving a designation for said other variable name displayed; and
a code for displaying said data classified with said other variable name designated.

16. A mail display method for displaying mail titles with a tree structure, comprising the steps of:
receiving a designation for said mail title or folder displayed with a tree structure;
displaying an other classification name to which said mail title or folder designated belongs;
receiving a designation for said other classification name displayed; and
displaying at least one of other folders or an other mail belonging to said classification designated.

17. A mail display system for displaying mail titles with a tree structure, comprising:
a processing unit for receiving a designation for said mail title or folder displayed with a tree structure;
a processing unit for displaying an other classification name to which said mail title or folder designated belongs;
a processing unit for receiving a designation for said other classification name displayed; and
a processing unit for displaying at least one of an other folder or an other mail belonging to said classification designated.

18. A program, executable by a computer, for displaying mail titles with a tree structure, comprising:
a code for receiving a designation for said mail title or folder displayed with a tree structure;
a code for displaying an other classification name to which said mail title or folder designated belongs;
a code for receiving a designation for said other classification name displayed; and
a code for displaying at least one of other folders or other mails belonging to said classification designated.

19. A database for managing data identifier names for displaying with a tree structure, comprising:
a first storage area for storing the identifier name of said tree structure to which said data identifier names belong, in correspondence with said data identifier names; and
a second storage area for storing other data identifier names, in said tree structure to which said data identifier name belongs, in correspondence with said data identifier name.

20. The database according to claim 1, wherein said data identifier name comprises at least one of an index number and node name for identifying said data, and said tree structure name comprises at least one of a tree structure number, tree structure name, and root node name for identifying said tree structure.
